(19) United States
(12) Patent Application Publication
(10) Pub. No.: US 2008/0060192 A1
(43) Pub. Date: Mar. 13, 2008

(54) HIGH PERFORMANCE NOSEPIECE FOR BLIND BOLT INSTALLATION

(75) Inventor: Cristinel Ovidiu Cobzaru, Murrieta, CA (US)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(73) Assignee: SPS TECHNOLOGIES, LLC, Jenkintown, PA (US)

(21) Appl. No.: 11/942,012

(22) Filed: Nov. 19, 2007

Related U.S. Application Data
(63) Continuation-in-part of application No. 11/760,908, filed on Jun. 11, 2007.
(60) Provisional application No. 60/807,202, filed on Jul. 13, 2006.

(51) Int. Cl. B23Q 7/10

(52) U.S. Cl. 29/812.5

(57) ABSTRACT

A nosepiece for use with a pulling head and a riveter for installing blind bolts, primarily the “Unimatic” or “U” type. The nosepiece is preferably made out of two different components (a hard and tough one acting as the interface to the fastener, and a soft, ductile one acting as a shock absorber) and has an active area which is annular and effectively matched to the dimensions of the locking collar of the blind bolt. No tapered surface interferes with the sleeve during installation of the blind bolt. Instead, the active area includes a protrusion which intersects a support surface generally at a ninety degree angle. Providing a minimum or no transition fillet radius from the active area to the support area allows for a minimum length of the active area, providing maximum reinforcement to the active area. It also concentrates the operating stresses in a known area, dispersing them from the critical, working surface of the active area, providing an expected failure mode. A two piece design dissipates the operating stresses away from the active area, moving the unavoidable failures to an internal area of the nosepiece that cannot affect installation of the fastener. This “stress and shock absorption” together with the design features described above leads to superior reliability and dramatic endurance improvements.

### BACKGROUND

The present invention generally relates to nosepieces for use with tools for installing blind bolts, and more specifically relates to a high performance nosepiece for use in such an application.

Blind bolts are popular fasteners, for example, in the aircraft industry. They are a good alternative to threaded fasteners, providing comparable joint preloads, with a better ability to resist vibration and the benefit of one side installation. A conventional blind bolt 10 is shown in FIG. 1 and includes a stein 12, a locking collar 14 and a sleeve 16. The stem 12 has a head 18 at one end 20 and a serrated portion 22 proximate an opposite end 24. As shown, the stem 12 extends through the sleeve 16 such that the head 18 of the stem 12 contacts an end 26 of the sleeve 16.

While FIGS. 5-8 relate to the present invention, reference can be made to these Figures with regard to explaining the manner in which a conventional blind bolt is installed. As shown in FIG. 5, to install such a blind bolt, the sleeve 16 of the blind bolt 10 is inserted into an aperture 28 in a workpiece 30 (which consists of two or more structures 30a, 30b), and the jaws 32 of a riveter 40 are used to grip and pull on a serrated stem 12 of the blind bolt. This causes a bulb 42 to form in the blind area 44 of the workpiece 30, as shown in FIG. 6, thereby providing a clamp up load to the workpiece structures 30a, 30b. While the jaws 32 of the riveter 40 pull on the stem 12, an installation load from the riveter 40 to the fastener 10 is transferred to the locking collar 14 of the blind bolt. This installation load is applied to a very small bearing area, which results in extremely high operating stresses. The high stress applied to the locking collar 14 is desirable, and is part of the installation process of the blind bolt 10. During installation, the high stresses developed in the locking collar 14 cause deformation of the locking collar 14 into a groove 46 on the stem, as shown in FIG. 7, which provides vibration resistance. Upon further pulling on the stem 12 by the riveter 40, the stern breaks as shown in FIG. 8 (at the notch 48 shown in FIGS. 5-7), completing the installation of the blind bolt 10.

Due to the locking collar 14, blind bolts such as shown in FIG. 1 are designed for minimal FOD (foreign object debris), a very desirable feature in the aircraft industry, for example. Other blind bolt designs also include a “shift washer” which is integral with the fastener and which provides the correct interface and installation for the locking collar. Upon installation, the shift washer falls. As such, the shift washer only has to withstand the stresses associated with a single installation. However, in the case of installing a blind bolt 10 such as is shown in FIGS. 1 and 5-8, the nosepiece of the riveter 40 has to provide the correct interface, set the locking collar 14 reliably and have a decent life and reliability. Furthermore, the nosepiece has to resist tremendous operating stresses, and retain its shape accurately so it can install correctly all fasteners within its lifespan.

Two nosepiece designs 50, 80 which are currently available in the industry are shown in FIGS. 2 and 3. As shown, both designs provide a long, slender, conical active area 52, 82 to interface with the locking collar 14. The fact that the active areas 52, 82 are conical provides that the active area 52, 82 interferes with an end surface 54 (identified in FIG. 5) of the sleeve 16 of the blind bolt 10. As a result, low nosepiece reliability and life are associated with both of these designs, and these issues are well known. In fact, the industry has tried over the years to eliminate these shortcomings, without success. The most significant improvement was the use of some exotic materials (like Vasco 350). However, the tool life improvement was incremental and reliability did not improve significantly.

Reliability of the designs shown in FIGS. 2 and 3 is low because at high levels of stress and not enough support of the active area 52, 82, any minor deviation or material, surface or heat treat flaw can cause part failure. As a result, the manufacturing tolerances surfaces and heat treat requirements are very tight, thereby making manufacturing very costly and causing high rejection rates.

Furthermore, the life of one of the nosepieces 50, 80 shown in FIGS. 2 and 3 can vary from a few installations (i.e., under ten) to a few hundred installations, and virtually identical nosepieces can have very different life expectancies, making the product very unreliable.

Finally, the designs shown in FIGS. 2 and 3 provide inconsistent and poor dimensional stability; they can also have several forms of failure that become very difficult to detect during operation. Therefore, if the nosepieces are not inspected carefully prior to being re-used, while the nosepiece appears to be in good condition, the dimensional changes may cause faulty fastener installation, a very undesirable outcome.

### OBJECTS AND SUMMARY

An object of an embodiment of the present invention is to provide an improved nosepiece for use with a riveter for installing blind bolts.

Another object of an embodiment of the present invention is to provide a nosepiece which provides a dramatically improved tool life, better reliability and better dimensional stability.

Yet another object of an embodiment of the present invention is to provide a nosepiece which provides a positive visual indication of structural failure.

Briefly, and in accordance with at least one of the foregoing objects, an embodiment of the present invention provides a nosepiece which has an active area which is annular and effectively matched to the dimensions of the locking collar of a blind bolt which the nosepiece is configured to install. The active area is configured to provide that no tapered surface interferes with the sleeve during installation of the blind bolt. Instead, the active area includes a protrusion which intersects a support area at a ninety degree angle. The transition from the protrusion to the support area surface may provide a fillet. Providing a minimum or no transition fillet radius from the active area to the support area allows for a minimum length of the active area, providing maximum reinforcement to the active area. It also concentrates the operating stresses this area, dispersing them from the critical, working surface of the active area, providing an expected failure mode. In other words, by providing a minimum or no transition fillet radius from the active area to the support area, the operating stresses are concentrated in this area. As such, when there is structure failure, such failure tends to occur at this location, causing the part to chip, thereby providing a positive, very easy visual indication of the working condition of the nosepiece. Preferably, an external surface of the nosepiece is threaded such that the nosepiece can be threaded into a riveter. Also, preferably a rear surface of the nosepiece is tapered and is configured to engage and spread open the jaws of a riveter, such that the stem of a blind bolt can be readily inserted into the riveter through a bore in the nosepiece, without the jaws interfering.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 illustrates a conventional blind bolt;

FIGS. 2 and 3 illustrate prior art nosepiece designs;

FIG. 4 illustrates a nosepiece which is in accordance with an embodiment of the present invention;

FIGS. 5-8 provide a sequence of cross-sectional views, showing the nosepiece of FIG. 4 being used in association with a riveter to install a blind bolt such as is shown in FIG. 1;

FIG. 9 illustrates a two component nosepiece configuration which is in accordance with an alternative embodiment (for dramatically improved performance) of the present invention;

FIG. 10 illustrates the nosepiece of FIG. 9, after significant use; and

FIGS. 11-13 illustrate the same body being used with three different inserts to install different size blind bolts.

### DESCRIPTION

While the present invention may be susceptible to embodiment in different forms, there is shown in the drawings, and herein will be described in detail, an embodiment thereof with the understanding that the present description is to be considered an exemplification of the principles of the invention and is not intended to limit the invention to that as illustrated and described herein.

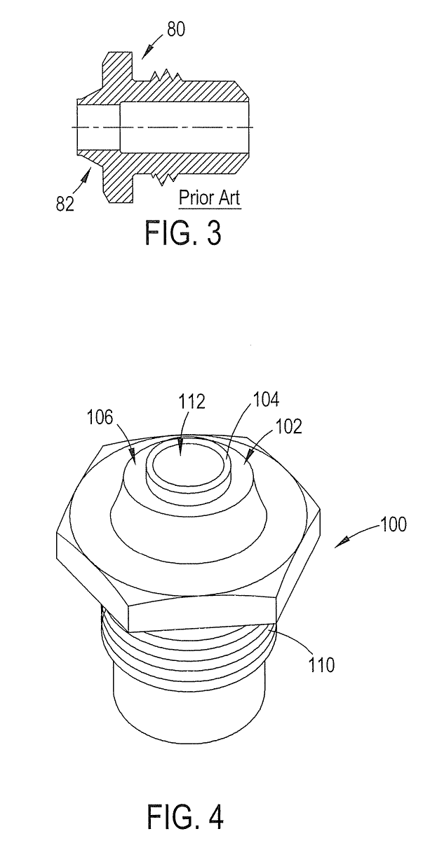

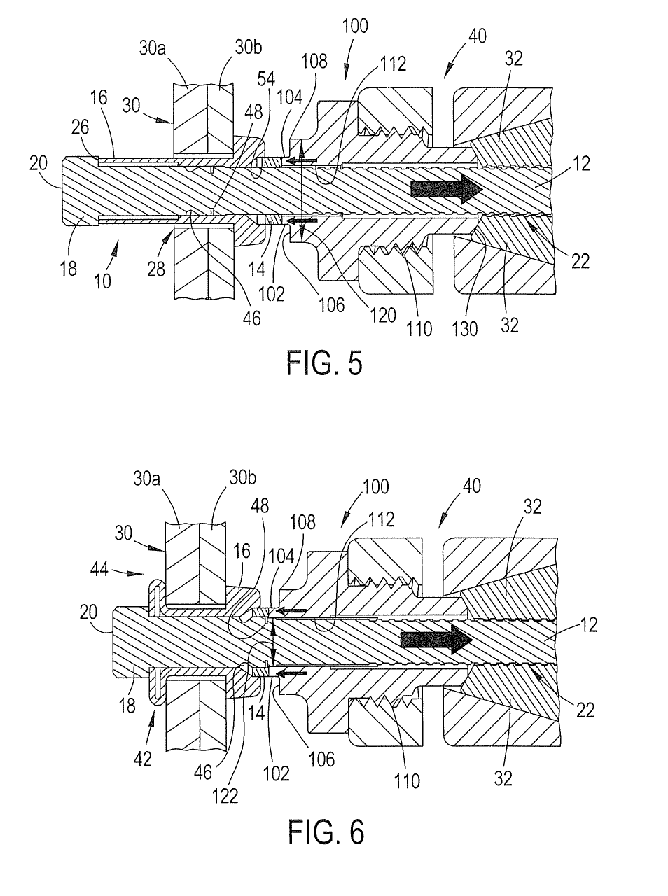

FIG. 4 illustrates a nosepiece 100 which is in accordance with an embodiment of the present invention. As shown, the nosepiece 100 has an active area 102 which includes an annular protrusion 104. The protrusion 104 is effectively matched to the dimensions of the locking collar 14 of a blind bolt 10 which the nosepiece 100 is configured to install. The active area 102 is configured to provide that, unlike the designs shown in FIGS. 2 and 3, no tapered surface interferes with surface 54 of the sleeve 16 of the blind bolt 10 during installation. Instead, the active area 102 includes a protrusion 104 which intersects a support area 106 at generally a ninety degree angle. The transition from the protrusion 104 to the intersecting, support area 106 may provide a fillet, and the support area 106 has an outer edge 108 which may also be rounded. An external surface 110 of the nosepiece 100 is threaded such that the nosepiece 100 can be threaded into a riveter 40, and more specifically into a pulling head which is engaged with a riveter 40. Specifically, the nosepiece 100 can be engaged with, for example, the following pulling heads: H955 pulling head, H9055 pulling head or a right angle pulling head such as the H866-3, 4, 5 or 6 pulling head, each of which is commercially available from Cherry Aerospace®. Also, the following riveters, for example, can be used: the G746a power riveter, the G747 power riveter, the G704B riveter, the G30 hand riveter or the G750A hand riveter, each of which is commercially available from Cherry Aerospace®. The riveter, pulling head and nosepiece can also be used to install, for example, Cherrylock® A Code fasteners, which are also commercially available from Cherry Aerospace®.

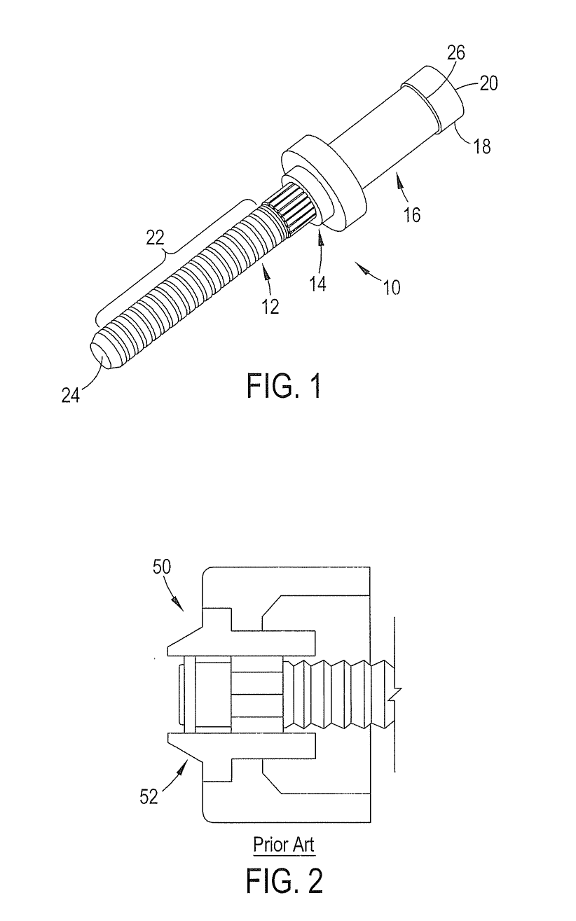

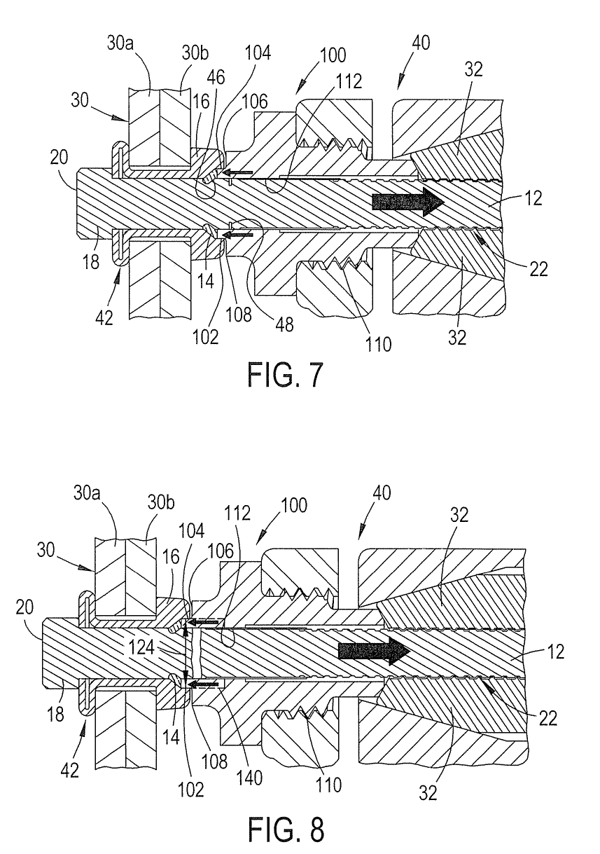

FIGS. 5-8 provide a sequence of cross-sectional views, showing the nosepiece 100 of FIG. 4 being used in association with a riveter 40 to install a blind bolt 100 such as is shown in FIG. 1. As shown, the nosepiece 100 has a throughbore 112 for receiving a stem 12 of the blind bolt 10, and the surface 106 which intersects with the annular protrusion 102 has an outside diameter (dimension 120 in FIG. 5) which is larger than both the inside diameter (dimension 122 in FIG. 6) and outside diameter (dimension 124 in FIG. 8) of the protrusion 102. Also, as shown in FIG. 5, preferably a rear surface 130 of the nosepiece 100 is tapered and is configured to engage and spread open the jaws 32 of the riveter 40, such that the stem 12 of the blind bolt 10 can be readily inserted into the riveter 40, through the bore 112 in the nosepiece 100, without the jaws 32 interfering.

To install the blind bolt 10, the sleeve 16 of the blind bolt 10 is inserted into an aperture 28 in a workpiece 30, as shown in FIG. 5, and the stem 12 of the fastener 10 is inserted into the nosepiece 100, such that the annular protrusion 102 contacts the locking collar 14 of the fastener 10. Then the riveter 40 is actuated, causing the jaws 32 of the riveter 40 to grip and pull on the serrated stein 12 of the blind bolt 10. This causes a bulb 42 to form in the blind area 44 of the workpiece 30, as shown in FIG. 6, thereby providing a clamp up load to the workpiece structures 30a, 30b. While the jaws 32 of the riveter 40 pull on the stem 32, an installation load from the riveter 40 to the fastener is transferred by the nosepiece 100 to the locking collar 14 of the blind bolt 10. This installation load is applied to a very small bearing area, which results in extremely high operating stresses. The high stress applied to the locking collar 14 is desirable, and is part of the installation process of the blind bolt 10. During installation, the high stresses developed in the locking collar 14 cause deformation of the locking collar 14 into a groove 46 on the stem 12, as shown in FIG. 7, which provides vibration resistance. Upon further pulling on the stein 12 by the riveter 40, the stein 12 breaks as shown in FIG. 8, completing the installation of the blind bolt 10.

As shown in FIGS. 5-8, the active area 104 is annular, short and stubby, with a minimum fillet radius at the transition to the support area 106. Since the fillet radius would interfere with the setting of the locking collar to the full depth, this portion has to be compensated by increasing the length of the protrusion 102 (i.e., the extent to which the protrusion 104 extends from the support area 106). By keeping this to a minimum, the feature is as stubby as necessary. The dimensions of the protrusion 102 (i.e, the inside diameter (dimension 122 in FIG. 5) and the outside diameter (dimension 124 in FIG. 8) closely match the fastener dimensions, providing maximum bearing surface for the active area. The protrusion length (i.e., the extent to which the protrusion 104 extends from the support area 106) of the annular active area 104 closely matches the maximum standard requirement for setting the locking collar 14. As such, during installation, the fastener 100 is precisely guided and centered during installation and by keeping corner breaks of the work surface to an absolute minimum.

Providing a minimum or no transition fillet radius from the active area 104 to the support area 106 allows for a minimum length of the active area, providing maximum reinforcement to the active area. It also concentrates the operating stresses in this area, dispersing them from the critical, working surface of the active area, providing an expected failure mode. In other words, by providing a minimum or no transition fillet radius from the active area 104 to the support area 106, the operating stresses are concentrated in this area. As such, when there is structure failure, such failure tends to occur at this location, causing the part to chip, thereby providing a positive, very easy visual indication of the working condition of the nosepiece. Furthermore, the two piece embodiment displaces most of the stress from this area to an area inside of the softer body, acting as a shock absorber, increasing the life of this design dramatically.

The short, stubby design provides excellent support to the stress area, keeping the active area rigid. Buckling and radial plastic deformation of the annular area are not possible. The only failure mode allowed by the current design is compressive (axial), and that can be controlled very well by the mechanical properties of the material used, and by using a two piece design to further reduce the stresses in the active area.

The nosepiece area 106 behind the active annular feature 104 is quite sizeable by comparison, able to absorb considerable shock and provide the much needed hoop (radial) strength. Corner breaks at the outside diameter/inside diameter of the annular active area are minimal, to keep the load bearing area as large as possible.

The nosepiece 100 shown in FIGS. 4-8 provides dramatically improved tool life (such as 600 to 1200 installations), good reliability (in extensive tests, all nosepieces such as is shown in FIGS. 4-8 had similar life expectancy, within reasonable margins) and dimensional stability (the design is very rigid, with very little or no dimensional changes being possible over the life of the nosepiece).

Furthermore, the nosepiece 100 shown in FIGS. 4-8 is configured to provide a positive visual indication of structural failure. This is because, in operation, the stress is concentrated in a known area, away from the working surface, and that is precisely where failure occurs. When that happens, the material in the stressed area chips away, providing an excellent visual indication of the failure. By comparison, the designs 50, 80 illustrated in FIGS. 2 and 3 do not behave consistently, progressively deforming over the life of the nosepiece. As such, if the nosepieces are not inspected carefully prior to being re-used, and a nosepiece has suffered dimensional changes, there could be faulty fastener installation.

In an alternative embodiment, significantly improving the life and reliability of this design, the annular area 104 can be a separate component made out of a different material and to higher precision requirements, pressed or otherwise mounted into the body of the nosepiece. This option is represented by the dotted line 140 in FIG. 8.

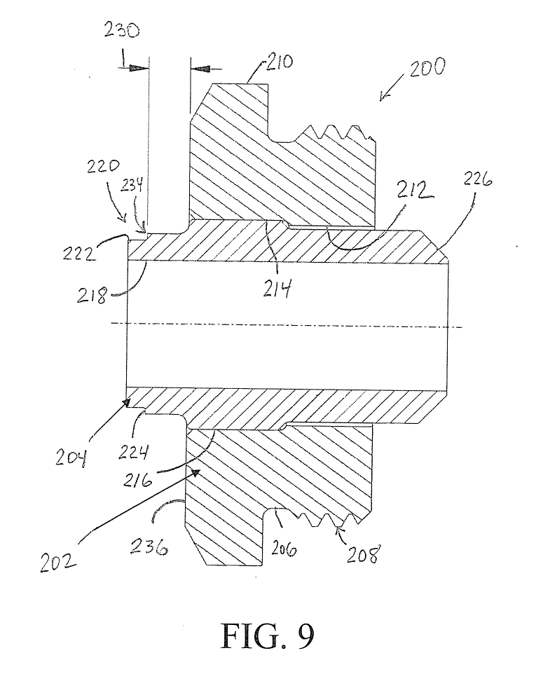

FIG. 9 illustrates a nosepiece 200 which is in accordance with an alternative embodiment of the present invention. The nosepiece 200 consists of two separate components—a body 202 and an insert 204 which is pressed into the body 202. An external surface 206 of the body 202 includes threads 208 so that the nosepiece 200 can be threaded into a pulling head used with a riveter, such as the pulling head 40 shown in FIGS. 5-8, much like nosepiece 100. The body may also be made press fit into the pulling head. The body 202 preferably includes a hex-shaped portion 210 for engagement with a tool, and includes a stepped central throughbore 212 in which the insert 204 is pressed. The throughbore 212 in the body 202 preferably includes an increased diameter portion 214 which receives an increased diameter portion 216 of the insert 204. The insert 204 also includes a central throughbore 218, and includes a front end surface profile 220 which provides an active area 222 that intersects a support area 224 at generally a ninety degree angle, much like nosepiece 100. Preferably, like nosepiece 100, a rear surface 226 of the insert 204 of the nosepiece 200 is tapered or conical and is configured to engage and spread open the jaws 32 of the riveter 40, such that the stem 12 of a blind bolt 10 can be readily inserted into the riveter 40, through the bore 218 in the insert 204, without the jaws 32 interfering.

While the insert 204 is made out of a very hard and tough material, such as Maraging 350, to resist the tremendous installation loads and shocks developed during tool operation, the body 202 is made out of a much softer, ductile material, such as a low alloy steel, acting as a shock absorber to the insert 204 which is pressed into the body 202.

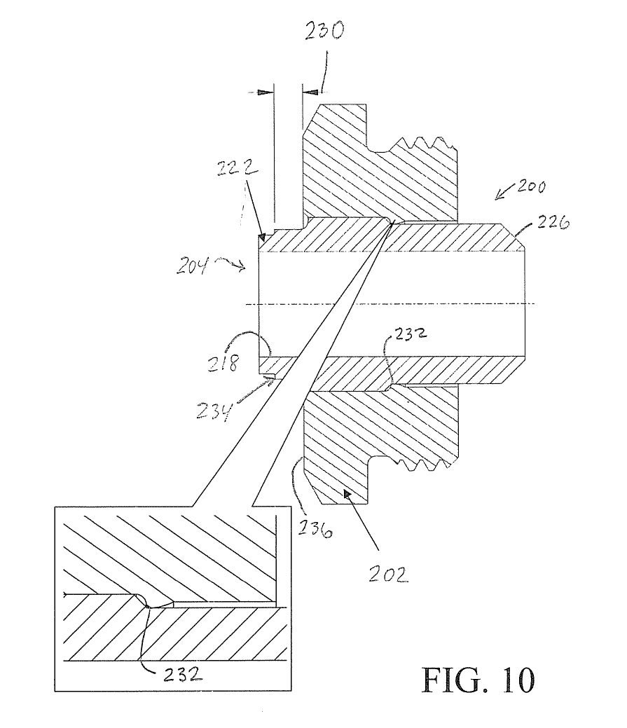

During use, the fact that the body 202 is softer than the insert 204 provides that the body 202 allows the insert 204 to embed into the body 202 slightly with each cycle, transferring most of the shock load away from the active area 222 of the insert 204. The unavoidable failure is therefore transferred to the softer body 202, to an area that will not impede the proper performance of the nosepiece 200, improving significantly the life of the nosepiece 200 by deflecting shocks away from the active area 222. As an example, as shown in FIG. 9, the insert 204 may initially protrude from the body 202 by 0.064 inches (dimension 230 in FIG. 9). However, as an example, as shown in FIG. 10, after significant use the insert 204 may embed into the body 202 by as much as 0.010 inches, causing the insert 204 to only end up protruding from the body 202 by 0.054 inches (dimension 230 in FIG. 10), and a deformation bulb 232 may end up forming in the body.

A shoulder 234 is provided on the insert 204, and the shoulder 234 provides a visual indication of the status of the nosepiece 200. For example, the nosepiece 200 may be used as long as the shoulder 234 is above or flush with a front surface 236 of the body, and the active area 222 is in good condition (i.e., has no fractures or deformations).

As discussed above, a rear surface 226 of the insert 204 is tapered or conical and is configured to engage and spread open the jaws of a riveter. Since the jaws of a conventional riveter are very hard with sharp edges, and the body 202 is made of soft material, the back end of the body 202 cannot be used to open the jaws because this would result in premature wear. To avoid this issue, the rear surface 226 of the harder insert 204 is configured to engage and open the jaws instead.

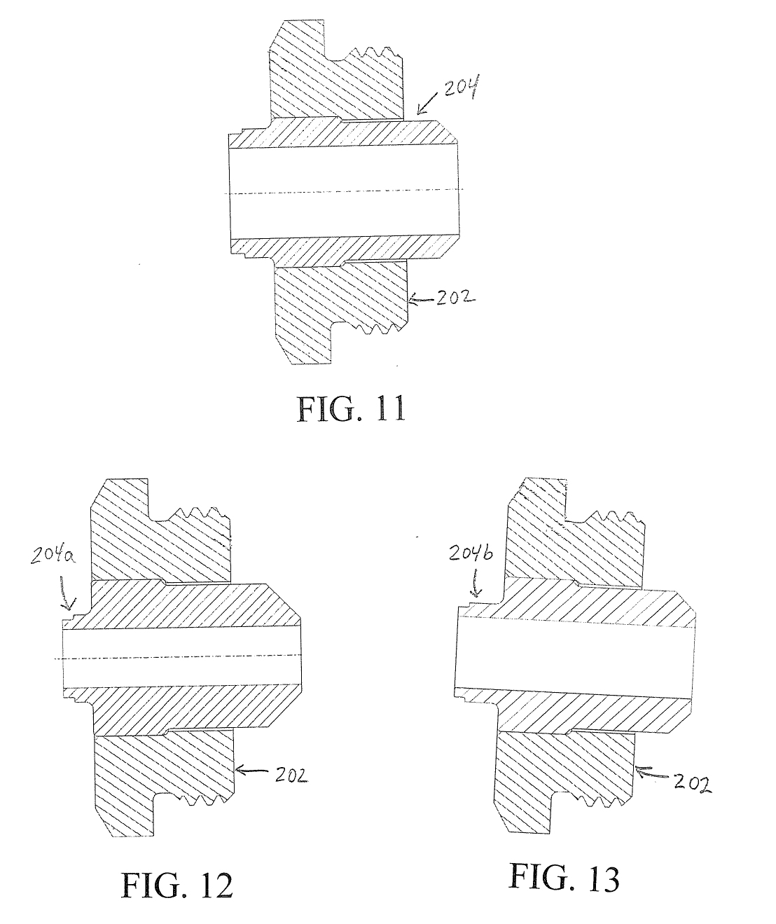

Preferably, the nosepiece 200 is configured such that it is designed modular so that one body 202 can take multiple size inserts. For example, FIGS. 10, 11 and 12 show the same body 202 receiving three different sized inserts—an insert 204 for accommodating a—8 blind bolt (see FIG. 10), an insert 204a for accommodating a—6 blind bolt (see FIG. 11), and an insert 204b for accommodating a—5 blind bolt (see FIG. 12). This keeps production cost down and simplifies product structure. Additionally, due to this feature the insert could be pressed directly into the body of a pulling head when space constraint is a big issue.

While embodiments of the present invention are shown and described, it is envisioned that those skilled in the art may devise various modifications of the present invention without departing from the spirit and scope of the disclosure.

What is claimed is:

1. A multiple component nosepiece which is configured to engage a riveter and engage a locking collar of a blind bolt, said nosepiece comprising: a body which is configured to engage the riveter; and an insert which is engaged with the body, said insert comprising a protrusion which is configured to engage the locking collar of the blind bolt

2. A multiple component nosepiece as recited in claim 1, wherein the insert further comprises a support area, wherein said protrusion intersects the support area at a ninety degree angle.

3. A multiple component nosepiece as recited in claim 1, wherein the insert is formed of a harder material than the body.

4. A multiple component nosepiece as recited in claim 1, wherein the insert is press fit into the body.

5. A multiple component nosepiece as recited in claim 2, wherein a fillet is disposed at a point at which the protrusion intersects the support area.

6. A multiple component nosepiece as recited in claim 2, wherein said protrusion and said support area define an active area of the nosepiece, wherein said active area is configured to provide that no tapered surface interferes with a sleeve of the blind bolt during installation of the blind bolt.

7. A multiple component nosepiece as recited in claim 2, wherein a fillet is disposed at a point at which the protrusion intersects the support area, and wherein said protrusion and said support area define an active area of the nosepiece, wherein said active area is configured to provide that no tapered surface interferes with a sleeve of the blind bolt during installation of the blind bolt.

8. A multiple component nosepiece as recited in claim 1, wherein an external surface of the nosepiece is threaded or press fitted such that the nosepiece is threadable or pressed into a pulling head.

9. A multiple component nosepiece as recited in claim 1, wherein a rear surface of the nosepiece is tapered and is configured to engage and spread open jaws of the riveter, such that a stein of the blind bolt is readily insertable into the pulling head through a bore in the nosepiece, without the jaws interfering.

10. A multiple component nosepiece as recited in claim 1, wherein an external surface of the nosepiece is threaded such that the nosepiece is threadable into the pulling head, or press fitted to the pulling head, and wherein a rear surface of the nosepiece is tapered and is configured to engage and spread open jaws of the riveter, such that a stem of the blind bolt is readily insertable into the riveter through a bore in the nosepiece, without the jaws interfering.

11. A multiple component nosepiece as recited in claim 1, wherein the body is configured such that a plurality of different inserts are engageable with the insert.

12. A multiple component nosepiece as recited in claim 1, wherein an internal surface of the body provides a deformation bulb as a failure mode, thus removing the possibility of failure of the critical active area.
